(19) United States
(12) Patent Application Publication
(10) Pub. No.: US 2021/0125598 A1
(43) Pub. Date: Apr. 29, 2021

(54) Active Noise Absorption Method and Device with Resonance Frequency Tracking

(71) Applicant: Baisheng Yu, Erie, PA (US)

(72) Inventor: Baisheng Yu, Erie, PA (US)

(21) Appl. No.: 16/664,903

(22) Filed: Oct. 27, 2019

(51) Int. Cl. G10K 11/172; G10K 13/00

(52) U.S. Cl. CPC G10K 11/172; G10K 13/00

(57) ABSTRACT

This invention provides a noise absorption method and device with an adjustable conical shaped annular aperture on a Helmholtz resonator composed of a Helmholtz resonant cavity, a resonance control package, a sensing & actuating modules and a controller. The resonant cavity harvests noise energy by tracking of the noise resonance frequency which is achieved by adjusting the aperture openness between a movable conical shell and the resonant cavity according to a resonance control algorithm of combination of FFT (Fourier Fast Transform) adjustment and PLL (Phase-Locked Loop control) adjustment.

Meanwhile, the controller applies a driving current into a coil attached to the movable conical shell based on DXHS (Delayed-X Harmonic Synthesizer) algorithm, so that harvested noise energy on the movable conical shell can be absorbed with maximum efficiency. Additionally, a part of the noise energy is dissipated by resonant air friction flowing through the annular aperture on the cavity.

### TECHNICAL FIELD

The invention relates in general to the field of active noise absorption, suppression method and device.

### BACKGROUND OF THE INVENTION

All existing methods of the active noise control are the methods based on the principle of acoustic wave interference. The methods of wave interference may suppress a noise strength in a specified control area, but the overall noise energy increases not only without decreasing. Compared with the principle of acoustic wave interference, the invention proposes an active energy absorption and friction dissipation method with noise resonance control which can decrease noise energy anywhere within a control area.

### SUMMARY OF THE INVENTION

The invention provides an active noise absorption method and device with an adjustable conical shaped annular aperture, it is composed of a Helmholtz resonator, a resonance control package, sensing & actuating modules and a controller. Opening size of the conical shaped annular aperture on the Helmholtz resonator has been adjusted by applying a current into a driving coil winding on Inner wall of a movable conical shell to change resonance frequency of the Helmholtz resonator. In this way, to track dominant frequency of absorbed noise. So, ambient noise energy converts into resonance energy of air in the resonant cavity, in other word, ambient noise energy has been harvested by the resonant cavity. The energy of air in the resonant cavity is simultaneously dissipated and absorbed by two ways: the one is friction loss between high-speed resonant airflow and the narrow conical shaped annular aperture on the resonant cavity; the other is, a balance energy flow from the resonant cavity is converted into moving kinetic energy on the movable conical shell because the resonant air works on the movable conical shell, and the kinetic energy of the movable conical shell is absorbed by electromagnetic force by applying a current into the driving coil on the movable conical shell, so that a phase of the moving velocity of the movable conical shell is the same as a phase of the aerodynamic force upon the movable conical shell, and the moving amplitude of the movable conical shell is within a specified optimal range, so as to absorb the kinetic energy on the movable conical shell with electromagnetic force with maximum efficiency.

In short words, the method or device utilizes acoustic resonant cavity to harvest noise energy, in turn converts harvested energy to mechanical energy of the movable conical shell, then, to absorb it into electricity energy.

In the details, as mentioned above, the invention consists of:
a. a Helmholtz resonator is used for harvesting noise energy;
b. a resonance control package is used to track dominant frequency of noise for harvesting the energy, and to absorb, dissipate the harvested kinetic energy;
c. a sensing & actuating modules are used to amplify, filter the sensing signals, and to drive the driving coil which current can be measured;
d. a group of sensors including two acoustic sensors positioned outside and inside of the resonator, an accelerometer of the movable conical shell and a current sensor of the driving coil;
e. a controller is configured to acquire the sensor signals and calculate output in real time in accordance with control algorithm to ensure that the resonance is tracked and the harvested kinetic energy on the movable conical shell is efficiently absorbed by applying a required current into the driving coil.

In the description hereinbelow, unless indicated otherwise, vertical direction refers to the direction of the vertical axial x in FIG. 1A, and absorber refers to the invention method and device.

1. Helmholtz Resonator
A Helmholtz resonator is a resonant cavity with an annular aperture. As shown in FIG. 1A, a Resonant cavity 13 is formed by screwing of a Top Cover 10, a Cylindrical Housing 11 and a Bottom Cover 12, then a neck of conical shaped annular aperture on the resonant cavity is constructed by Bracket of Conical Shell 34 and Top Cover 10. A changing of gap openness of Conical Shaped Annular Aperture of 41 is achieved by adjusting position of Bracket of Conical Shaped Shell 34 along the vertical direction of the resonant cavity. The cavity and neck produce a resonance response to sound wave of noise source if resonance frequency is matched with dominant frequency of noise source. The Opening Gap of Conical Shaped Annular Aperture 41 determines the resonance frequency of the resonant cavity, and this opening gap can be adjusted according to a change of dominant frequency of noise source, so that the Resonant Cavity 13 is always resonated by noise source. Thus, ambient noise energy is harvested by the Resonant Cavity 13. Furthermore, when the resonance occurs, resonant air in the cavity excited by noise source reciprocates through the narrow conical shaped annular aperture at high speed, which produces a relative magnitude of energy friction dissipation. Two acoustic sensors (50 and 51) are mounted outside and inside of the resonant cavity respectively. The Top Cover 10 is a non-magnetic material such as aluminum alloy and austenitic high manganese steels.

2. Resonance Control Package
A resonance control package is a kernel part of the invention method and device, it is composed of a magnetic module of the components 20˜23 and a winding module of the components 30˜37. The magnetic module is composed of an Upper Magnetic Pole 20, a Magnet 21, a Lower Magnetic Pole 22, and Fastener for Magnetic Components 23. The Upper Magnetic Pole 20 and the Lower Magnetic Pole 22 are fastened directly to different polarities of the Magnet 21 and form a magnetic flux throughout air gap between the Upper Magnetic Pole 20 and the Lower Magnetic Pole 22 where is located the Bracket of conical Shaped Shell 34 with the Driving Coil 37 supported elastically by the Trilobal Metal Springs 30. The resonance control makes the absorber in resonance working status, so that vibrational frequency of air in the cavity corresponds to noise dominant frequency. All of movable components is named as a module of the movable conical shell, it is an electromagnetic actuator positioned in central of the conical shaped aperture of the Resonant Cavity 13. The module of the movable conical shell is complicated, consisting of Trilobal Metal Springs 30, Bracket of Conical Shaped Shell 34, six of Fastener 36, Driving Coil 37 and Accelerometer 52. The module of the movable conical shell is located at center of the Top Cover 10 of the Helmholtz resonator, and its axis of symmetry coincides with axis of symmetry of the conical shaped aperture of the resonant cavity, supported by Trilobal Metal Springs 30. The Trilobal Metal Springs 30 is a flexible suspension with mechanical damping. The outer ends of the Trilobal Metal Springs 30 are bolted by fasteners for outer ends 31˜33 while the inner end of the Trilobal Metal Springs 30 is bolted to the Bracket of Conical Shaped Shell 34 by the six Fasteners 36. When applying a current into the Diving Coil Winding on Inner Wall of the Bracket of Conical Shaped Shell 37, an electromagnetic driving force push on the movable conical shell to cause a vertical direction movement of the axial x, and so the magnetic flux is cut. The Upper Screw Nuts of the Fastener for the Outer Ends 32 and the Lower Screw Nuts of the Fastener for the Outer Ends 33 are served as a manually adjustment of the opening gap of the conical shaped annular aperture of the resonant cavity. A formula for relationship of an opening gap of the conical shaped annular aperture and a vertical direction movement is Δδ=Δx*cos β, where Δδ is an increment of the opening gap δ, Δx is a displacement increment of the movable conical shell along the vertical direction; β is a conical angle of the conical shaped annular aperture. The Opening Gap of the Conical Shaped Annular Aperture 41 is adjusted by the following two approaches:
a. Mutually Adjustment Selection of an Operating Frequency Band
   Manually adjusting the Upper Screw Nuts of the Fastener for the Outer Ends 32 and the Lower Screw Nuts of the Fastener for the Outer Ends 33 to change the Opening Gap of Conical Shaped Annular Aperture 41 to select a band of resonance operating frequency. And three sets of fasteners at the outer end of the Trilobal Metal Springs 30 are simultaneously adjusted to ensure the symmetry axis of the movable conical shell coincides with the symmetry axis of the conical shaped aperture on the resonant cavity.
b. Automatic Adjustment Tracking of Noise Dominant Frequency
   Initially, a bias current of the Driving Coil Winding on Inner Wall of the Bracket of Conical Shaped Shell 37 is supplied according to noise dominant frequency measured by the Acoustic Sensor Outside of the Resonant Cavity 50, and then a Phase-Locked Loop algorithm is used to adjust the bias current using signals of the sensor 50, 51 as the inputs, so that the dominant frequency of the absorbed noise is automatically tracked within the manually selected resonance frequency band.
An Accelerometer 52 is arranged on the inner wall of the Bracket of Conical Shaped Shell 34 is for obtaining movement information in the vertical direction of the movable conical shell. When a resonance occurs, the movable conical shell is forced by the air pressure inside and outside of the Helmholtz resonator, and high-speed alternately airflow goes through the narrow conical shaped annular aperture of the resonant cavity. An excessive vibrational amplitude of the movable Conical shell will affect resonance stable status of the Helmholtz resonator. In the other hand, in the case where an amplitude of the movable conical shell does not interfere with the resonance stable status of the Helmholtz resonator, the amplitude should be maximized, so that more energy of the movable conical shell can be obtained from aerodynamic work of the Helmholtz resonator, it means that the amplitude of the movable conical shell can neither be too large nor too small, it should be in an suitable range. Therefore, driving current in the coil of the movable conical shell is controlled to maximize the work of the aerodynamic force on the movable conical shell and maximize absorb it by electromagnetic force.

3. Sensing & Actuating Modules
(1) Allocation of the sensors
The invention method and device are designed with four sensors. Two of them are acoustic sensors disposed outside and inside of the cavity of the Helmholtz resonator respectively, an accelerometer is mounted on the inner wall of the movable conical shell, a coil current sensor is arranged in a driving circuit of the Actuating Module 120. In the details, it is listed below
   a. Acoustic Sensor Outside of the Resonant Cavity 50 is for measuring noise signal;
   b. Acoustic Sensor Inside of the Resonant Cavity 51 is for measuring resonance signal;
   c. Accelerometer attached onto the Bracket of Conical Shell 52 N for measuring acceleration signal of the movable Conical shell;
   d. Current Sensor of the Driving Coil 53 is for measuring current signal of the Driving Coil on the Movable Cone Shell.
(2) Sensing module
   The sensing Module 110 is a pretreatment interface of sensing signals between the sensors and the controller. The pretreatment interface circuit may include amplifiers, filters, A/D conversion, etc. Some of them might be not included in the interface circuit, if a MEMS sensor is used.
(3) Actuating module
   A function of the Actuating Module 120 is to accept a digital control signal in a form of PWM or PDM from the controller, and to control a bridge amplifying circuit, output of which is to drive the Coil Winding on Inner Wall of the Bracket of Conical Shaped Shell 37. Meanwhile, current of the coil is measured by Current Sensor of the Driving Coil 53 in the Actuating Module 120 and output it to the Controller of the Method and Device 100.
4. Controller
   The Controller 100 is responsible for acquiring the sensor signals 50˜53, applying a current into the Driving Coil 37 based on the control algorithm 130, 140, adjusting the Opening Gap of the Conical Shaped Annular Aperture 41 to change the resonance frequency of the resonant cavity. If an environmental noise source is changed during occurring of a resonance, the dominant frequency of the absorbed noise is adaptively tracked to maintain the resonance status. Additionally, it is necessary to control vibrational amplitude of the movable conical shell within a specified range, so that maximize to absorb vibrational energy on the movable conical shell using electromagnetic force.
   In the point of functional view, the Controller 100 is divided into three units, a Resonance Control Unit 140, an Absorbing Control Unit 130 and a Calibration Unit of the Control Parameters 160. The Resonance Control Unit 140 and the Absorbing Control Unit 130 are interdependent, support each other and work together. A direct current (DC) I_{coil}^{dc} of the driving coil is used to control resonance status while an alternating current (AC) I_{coil}^{ac}(n) of the driving coil is used to control absorption of the vibrational energy on the movable conical shell. The currents, voltages and electromagnetic forces for the driving coil are below:

I_{coil}(n)=I_{coil}^{dc}+I_{coil}^{ac}(n)

V_{dri}(n)=C_{dri}^{dc}+V_{dri}^{ac}(n)

F_{elc}(n)=F_{elc}^{dc}+F_{elc}^{ac}(n)
The vibrational amplitude of the movable conical shell is an extremely important control parameter, which is not only related to stability of the resonance, but also related to the absorption capability for the harvested energy. Therefore, one limitation of the amplitude of the movable conical shell is that shouldn't cause an instability of the resonance status of the absorber, and other limitation of the amplitude of the movable conical shell is to absorb the harvested energy as much as possible.
A Voltage Control Signal for the Driving Coil 101 from the Controller 100 is connected to the Actuating Module 120, it is given preferably in the form of PWM/PDM, and it goes into a bridge amplifying circuit in the Actuating Module 120, then output a driving current into the coil 37 on the Bracket of Conical Shaped Shell 34, to produce an electromagnetic force, and to push the movable conical shell, in this way to absorb the harvested energy.
(1) Resonance control unit—maintaining resonance
   A task of the Resonance Control Unit 140 is to maintain resonance status of the Helmholtz resonator. The Resonance Control Unit 140 tracks a change of dominant frequency of the noise source by adjusting the opening gap of the conical shaped annular aperture 41 between the movable conical shell and the resonant cavity, so that the resonant cavity is always in a status of being resonated by the noise source, in this way to harvest the noise energy. A mechanism of algorithm of the Resonance Control Unit 140 is to firstly perform FFT (Fourier Fast Transformation) on pₑₓ(n)—the signal of Acoustic Sensor Outside of the Resonant Cavity 50 for calculation of the dominance noise frequency ωₑₓ and then look up table ωₒ−xₒ to find a corresponding displacement xₑₓ of the movable conical shell and output a generated corresponding driving current. This process is a coarse adjustment (FFT control); on the other hand, using PLL (Phase-locked Loop) for more accurately control, take pₑₓ(n) as a input reference signal, calculate phase difference u_{d} between pᵢₙ(n) and pₑₓ(n), and then look up table u_{d}−Δxₒ to find out a corresponding adjusted displacement xₑₓ of the movable conical shell Δx₀ and output a generated driving current, this process is a fine adjustment (PLL control). The coarse adjustment (control variable xₑₓ) and the fine adjustment (control variable Δx₀) are performed simultaneously during the control process and output a sum of them. The Look-up Table 142 for ωₒ−xₒ and the Look-up Table 156 for u_{d}−Δxₒ are obtained by processing of offline parameter calibration. The PLL adjustment compensates error of the FFT coarse adjustment. There is a formula for calculation of Δδ—increment of Opening Gap of Annular Shaped Aperture base on Δx₀—increment of displacement of the movable conical shell.

Δδ=Δx₀ cos β
The resonance frequency represents below:

$${ω}_{H R} = {c}_{0} \cdot \sqrt{\frac{{S}_{H R}}{{V}_{H R} \cdot {L}_{e}}}$$

The cross section of the conical shaped annular aperture represents below:

$${S}_{H R} = {π [ \frac{{D}_{0}}{2 sin β} ]}^{2} - {π [ \frac{{D}_{0}}{2 sin β} - δ ]}^{2}$$

The relationship between the coil bias voltage V_{dri}^{dc} and the displacement adjustment of the movable conical shell x₀ is:

$$K \cdot {x}_{0} = {F}_{elc}^{d c} = {c}_{m} \cdot ψ ( x ) \cdot {I}_{coil}^{d c}$$

$${V}_{dri}^{dc} = \frac{K \cdot R}{{c}_{m} \cdot ψ ( x )} \cdot {x}_{0}$$

In summary, the algorithm of resonance control synchronizes the resonance frequency of the resonant cavity with the dominant frequency of noise source by tracking a change of the dominant frequency of noise source using combination of FFT coarse adjustment and PLL fine adjustment. A quality criterion of the resonance control is that how good to match between the dominant frequency of noise w and the resonance frequency of the cavity ωᵢₙ, and how much is a resonant ratio of the two amplitudes Aᵢₙ/Aₑₓ.
(2) Absorbing control Unit absorption of harvested noise energy
   A task of the Absorbing Control Unit 130 is to absorb noise energy harvested by the resonant cavity on the movable conical shell with maximum efficiency. This requires that the phase of moving velocity of the movable conical shell is the same as the phase of aerodynamic force in the movable conical shell, and the amplitude of ideal control target of the movable conical shell should be within a specified range. The absorbing control unit controls vibrational amplitude of the movable conical shell, so that it matches with Aₓ^{t}—amplitude of ideal control target, to insure the frequency of driving current in the coil match with the vibrational frequency of the movable cone shell, and the phase of driving current in the coil is opposite to the phase of vibrational velocity of the movable conical shell. The controller utilizes a signal preferably coming from the accelerometer to synchronize the aerodynamic forced with the vibrational velocity of the movable conical shell.
   The amplitude of the ideal control target Aₓ^{t} is to satisfy the following three conditions:
      a. The resonance status of Helmholtz resonator is stable;
      b. The movable conical shell acquires harvested energy in maximum;
      c. The electromagnetic force of the coil absorbs kinetic energy on the movable conical shell in maximum.
   Here is the velocity of ideal control target of the movable conical shell:

v^{t}(n)=Aₓ^{t}·ωᵢₙ·sin(ωᵢₙ·n+φᵢₙ)
The dynamic equation of the movable conical shell is:

M·\ddot{x}(t)+C·\dot{x}(t)+K·x(t)=Fₐᵢᵣ(t)+F_{elc}^{ac}(t)
wherein, Fₐᵢᵣ(t)=Hₐᵢᵣ(pₑₓ, pᵢₙ, x, t)
The electric driving equations for the movable conical shell are:

$${F}_{elc}^{ac} ( t ) = {C}_{m} \cdot ψ ( x ) \cdot {I}_{coil}^{a c} ( t )$$

$${E}_{d} ( t ) = {C}_{e} \cdot ψ ( x ) \cdot v ( t )$$

$${V}_{dri}^{a c} ( s ) - {E}_{d} ( s ) = ( L \cdot s + R ) \cdot {I}_{coil}^{a c} ( s )$$

$${I}_{coil}^{a c} ( s ) = \frac{{V}_{dri}^{ac} ( s ) - {C}_{e} ψ ( x ) \cdot v ( s )}{( L \cdot s + R )}$$

Therefore,

$$v ( s ) = {[ \frac{M \cdot {s}^{2} + C \cdot s + K}{s} + \frac{{C}_{m} \cdot {C}_{e} {ψ}^{2} ( x )}{L \cdot s + R} ]}^{- 1} \cdot [ {H}_{air} ( s ) + \frac{{C}_{m} \cdot ψ ( x )}{L \cdot s + R} \cdot {V}_{dri}^{a c} ( s ) ]$$

$$v ( s ) = {H}_{v} ( {p}_{ex} , {p}_{in} , x , {V}_{dri}^{d c} )$$

Nevertheless, due to above formulas, the phase of the ideal control target velocity of the movable conical shell may be different from the phase of the resonance in the cavity. It is important to control the actuator with high precision in terms of frequency and phase of the generated absorbing force.
The invention provides a mechanism of vibrational absorption for the movable conical shell which is to use DXHS (Delayed-X Harmonic Synthesizer) algorithm adaptively adjusts an increment of amplitude ΔA_{ac}(n+1) and an increment of phase Δφ_{ac}(n+1) for control voltage of the coil in order to the amplitude and the phase of the movable conical shell are matched to the amplitude and the phase of the ideal control target velocity base on a difference between the velocity v(n) of the movable conical shell and the velocity of the ideal control target v^{t}(n) as the algorithm residual e(n). Actually, the DXHS is a kind of waveform synthesis algorithm, the formulas for absorbing control of noise energy are below:

e(n)=v^{t}(n)−v(n)

ΔA_{ac}(n+1)=−μᵣ·e(n)·sin(ωᵢₙ·n+φ_{ac}(n))

Δφ_{ac}(n+1)=−μₚ·e(n)·cos(ωᵢₙ·n+φ_{ac}(n))

A_{ac}(n+1)=A_{ac}(n)+ΔA_{ac}(n+1)

φ_{ac}(n+1)=φ_{ac}(n)+Δφ_{ac}(n+1)

V_{dri}^{ac}(n)=A_{ac}(n)·sin(ωᵢₙ·n+L·φ_{ac}(n))
Wherein, an initial amplitude A_{ac}(0) and an initial phase φ_{ac}(0) are derived from the signal a_{cc}(n) as shown in FIG. 2; and L is a stability factor greater than one.
When the controller enters a stable operation, it forms a balanced energy flow from a noise energy to an electrical energy. That is: firstly, a resonance caused by the controlled noise converts the noise energy into a resonance energy of air in the resonant cavity, and the resonance air forces on the movable conical shell, so this converts the resonance energy if air into a vibrational energy on the movable conical shell, finally, an electromagnetic force performs a negative work on the movable conical shell, it converts the vibrational energy on the movable conical shell into the electrical energy.
(3) Parameter calibration unit calibrating and initializing parameters
   There are three groups of important control parameters needed to calibrate for the Parameter Calibration Unit 160 below:
      a. The parameters of velocity vector of the ideal control target Aₓ^{t}, φᵥ^{t}
      b. The parameters of Look-up Table for ωₒ−xₒ
      c. The parameters of Look-up Table for u_{d}−Δxₒ
   These parameters are needed to calibrate after each manually adjustment of the opening gap of the conical shaped annular aperture, in other words that is after a selection of the operating frequency band. This is because a manually adjustment of the control screw nuts 32, 33 will change the opening gap of the conical shaped annular aperture of the resonant cavity, and the operating frequency band of the resonant cavity is changed.

### DESCRIPTION OF THE PREFERRED EMBODIMENTS

Hereinafter, a description is made for embodiments of the invention using related drawings. The invention (the method and device) are composed of Helmholtz resonant cavity 10˜12, resonance control package 20˜37, sensor group 50˜53, sensing & actuating modules 110, 120 and controller 100 as shown in FIG. 1 and FIG. 2. The FIG. 2 is a block diagram of algorithm architecture of the method and device according to an embodiment of the invention.
The controller's operation includes three processes which is depicted below:
1. The Startup Process of Controller's Initialization
   At firstly, a controller's setting is to select a operational frequency band needed to operate on according to dominant frequency range of noise source, and then manually to adjust the Upper Screw Nuts 32 and the Lower Screw Nuts 33 of the Fastener for Outer Ends 31 of Trilobal Metal Springs 30 to change opening gap of the conical shaped annular aperture of the resonant cavity, thereby a resonance operating frequency band is manually selected. Having been aware that three nut's sets of the Upper Screw Nuts 32 and the Lower Screw Nuts 33 at the outer ends 31 for the Trilobal Metal Springs 30 are needed simultaneously adjust to ensure of coinciding of symmetry axis of the movable conical shell and symmetry axis of conical shaped aperture of the resonant cavity. Whenever once the system setting parameters are changed, especially after manually adjusting of the opening gap of the conical shaped annular aperture, the controller must need to be calibrated. There are four group of controller's parameters to be calibrated. The first three of them are related to the adjustment of the opening gap of the conical shaped annular aperture of the resonant cavity, and the last group is related to the absorbing control algorithm—DXHS (Delayed-X Harmonic Synthesizer).
   (1) A vibrational amplitude Aₓ^{t} and a velocity phase φᵥ^{t} of ideal control target for the movable conical shell
      A velocity of ideal control target on the movable conical shell is expressed as:

v^{t}(n)=Aₓ^{t}·ωᵥ^{t}·sin(ωᵥ^{t}·n+φᵥ^{t})
So, here are two parameters to be calibrated:
   a. Aₓ^{t}—vibrational amplitude of ideal control target for the movable conical shell;
   b. φᵥ^{t}—velocity phase of ideal control target for the movable conical shell.
A process of calibration for above two parameters is below:
It needs to use a smoothly frequency modulated device to radiate a sound as a simulated noise excitation source while the parameters are calculated. Initially, without applying any driving current on the driving coil, air in the resonant cavity and the movable conical shell are in static status. The simulated noise excitation source is started to excite with a frequency far away from the resonance frequency of the resonant cavity, then it changes the exciting frequency toward to the resonance frequency of the resonant cavity at enough slow speed (slowly frequency scanning). When the exciting frequency of the simulated noise source is close enough to the resonance frequency of the resonant cavity, air in the resonant cavity begins to be resonated, and the movable conical shell starts to vibrate also. At this time, a signal of the Acoustic Sensor of the Outside the Resonant Cavity 50, a signal of the Acoustic Sensor Inside of the Resonant Cavity 51, and a signal of Accelerometer 52 on the movable conical shell are expressed as:

pₑₓ(n)=Aₑₓ·sin((ωₑₓ·n+φₑₓ)

pᵢₙ(n)=Aᵢₙ·sin(ωᵢₙ·n+φᵢₙ)

a_{cc}(n)=Aₐ·sin(ωₐ·n+φₐ)
The corresponding velocity and displacement of the movable conical shell are calculated as:

$$v ( n ) = \frac{{A}_{a}}{{ω}_{a}} \cdot sin ( {ω}_{a} \cdot n + {φ}_{a} - \frac{π}{2} )$$

$$x ( n ) = \frac{{A}_{a}}{{ω}_{a}^{2}} \cdot sin ( {ω}_{a} \cdot n + {φ}_{a} - π )$$

An aerodynamic force on the movable conical shell is:

Fₐᵢᵣ(n)=Aₐᵢᵣ·sin(ωₐᵢᵣ·n+φₐᵢᵣ)
Let define the phase's relationship:

φᵢₙ=φᵢₙ₋ₑₓ+φₑₓ

φₐ=φₐ₋ᵢₙ+φᵢₙ
When the movable conical shell is subjected to the aerodynamic force only, the phase of displacement x(n) as a vibrational response is the same as the phase of the aerodynamic force, so it opposite with the phase of the vibrational acceleration a_{cc}(n), namely:

φₐᵢᵣ=φₐ−π
According to the summary section, φᵥ^{t} should be the same with φₐᵢᵣ, so, there are:

φᵥ^{t}=φₐ−π

φᵥ^{t}=φₐ₋ᵢₙ+φᵢₙ₋ₑₓ+φₑₓ−π
based on above formula, phase of the ideal control target velocity of the movable conical shell is calculated from the phase of the acceleration signal.
If a frequency of the simulated noise source is exactly matching with the resonance frequency of the resonant cavity, resonant ratio reaches a maximum:

$${λ}_{max}^{t} = \frac{{A}_{in}}{{A}_{e x}}$$

If there is not any driving current in the coil, when a resonance of the resonant cavity has been affected or interrupted since vibration of the movable conical shell coming too violently, an amplitude of the acceleration signal at this time is expressed Aₐ^{max}. So, vibrational amplitude of the ideal control target of the movable conical shell is obtained:

$${A}_{x}^{t} = \frac{{A}_{a}^{max}}{γ \cdot {ω}_{a}^{2}}$$

Here γ is a coefficient, and γ>1.
(2) Roughness adjustment table ωₒ−xₒ (FFT adjustment table)
   A coordinated zero of variable x₀ is defined as a point of intersection of the x coordinate axis and the top plane of the movable conical shell while there is no existing noise source, no coil driving current including resonance control current and absorption control current, and no movement of the movable conical shell. The steps for measuring resonance frequency of the resonant cavity are below:
      a. An alternating excitation current I_{coil}^{ac}(n) is applied to the driving coil attached to the movable conical shell in the conditions of without external noise interference and resonance control current I_{coil}^{dc}. Then frequency ω_{coil} of the alternating excitation current is enough slowly changed within the specified range. Meanwhile, when signal magnitude of the Sensor Inside of the Resonant Cavity 51 is becoming violently maximum, the frequency of the excitation current is considered as a resonance frequency of the resonant cavity at the zero position of x₀.
      b. Applying a bias current I_{coil}^{dc} of the resonance control on the coil in the movable conical shell, so a corresponding displacement of position of the movable conical shell along in the direction of coordinate axial x has been occurred, therefore, the opening gap of the conical shaped annular aperture of the resonant cavity has changed respectively. In this case using the step a. to iterate to find out resonance frequency of the resonant cavity corresponding to the applying current I_{coil}^{dc}.
      c. To iterate a. and b. steps so that the table ωₒ−Iₒ of the bias resonance current and the resonance frequency of the resonant cavity is obtained.
   Additionally, to convert the table ωₒ−Iₒ to the table ωₒ−xₒ using a formula below:

$${x}_{0} = \frac{{c}_{m} \cdot ψ ( x )}{K} \cdot {I}_{coil}^{d c}$$

And, the frequency range of resonance control of the resonant cavity depends on maximum forward bias current and maximum reverse bias current of the driving coil of the movable conical shell.
(3) Fine adjustment table u_{d}−Δx₀ (PLL adjustment table)
   The various deviations of the controller's parameters will occur due to the changes of operating environment. For an example, the resonance frequency of the resonant cavity will change with temperature and humidity of environment. In the resonance control algorithm, these changes are compensated by PLL (Phase-Locked Loop) adjustment. Moreover, the table ωₒ−xₒ (FFT-adjustment table) for the resonance roughness control has own control error which is needed to compensate with the PLL adjustment too.
   The maximum value of Δx₀ in the table u_{d}−Δx₀ should be greater than sum of all errors in the mentioned above. Moreover, the u_{d} is output of a phase difference after the module 155 in of the PLL adjustment:

u_{d}=½ sin(ωᵢₙ·n−ωₑₓ·n+φᵢₙ−φₑₓ)
Also, u_{d} and Δx₀ are linear in the table u_{d}−Δx₀.
(4) Parameters of step size in the DXHS algorithm—μₚ and μᵣ
   Use the parameter adjustment method in my previous patent “U.S. Pat. No. 10,355,670 B1” for the calibration or/and adjustment of the parameters μₚ and μᵣ used in the DXHS absorbing algorithm.
2. Description of the Control Process
   After the controller starts to operate, the Sensing Module 110 converts pₑₓ(t)—the signal of Sensor Outside of the Resonant Cavity 50, pᵢₙ(t)—the signal of the Sensor Inside of the Resonant Cavity 51, and a_{cc}(t)—the signal of Accelerometer on the Movable Conical Shell 52 to pₑₓ(n), pᵢₙ(n) and a_{cc}(n) respectively by amplifying, filtering, A/D conversing, and input them to the Controller 100. The FFT Calculation Module 141 is monitoring value of pₑₓ(n) in real time, if the value exceeds a certain threshold, noise dominant frequency ωₑₓ will have been calculated. The Module 142 inquires the table ωₒ−xₒ to find out a needed displacement xₑₓ of the movable conical shell, and the Module 144 outputs a corresponding bias current I_{coil}^{dc}. Finally, a bias voltage of the coil on the movable conical shell V_{dri}^{dc} is given by the module 145. This process is called as a resonance roughness control. In addition to this, the PLL algorithm Module 150 is used to compensate errors in the table ωₒ−xₒ and others, for the detailed as below: at the first, the pₑₓ(n) and pᵢₙ(n) need to normalize, after that, the phase of pₑₓ(n) is shifted in π/2 by the Module 152, its output is multiplied by the pᵢₙ(n), then result is gone through the Lowpass Filter Module 155, the output of the Module 155 is a phase difference u_{d} between the phases of pₑₓ(n) and pᵢₙ(n), then the u_{d} enters into Module of Look-up Table u_{d}−Δxₒ 156. Finally, a displacement Δx₀ of needed adjustment of the movable conical shell corresponding thereto is found using of the table u_{d}−Δxₒ, and this value enters the Combiner Module 143 to complete the PLL compensation control. In the reality, FFT-adjustment—x₀ and PLL compensation—Δx₀ are simultaneously adjusted, and the result goes to the Modules of 144, 145, then a coil control voltage V_{dri}^{dc} obtained for resonance sustaining enters the Module 101. In this way, according to a change of dominant frequency of a noise source, a position of the resonance frequency in the manually selected resonance frequency band is adaptively tracked, that is, the dominant frequency of absorbed noise source is tracked in real time, so the resonance status of noise source is maintained by the resonance control algorithm. The Look-up Table ωₒ−xₒ 142 and the Look-up Table u_{d}−Δxₒ 156 used here are obtained from the section of The Startup Process of Controller's Initialization.
   From the section of the Summary, it is known that in order to for electromagnetic force to absorb collected noise energy on the movable conical shell to maximum extent, it needs to control the alternating excitation current I_{coil}^{ac}(n), so that v(n) reaches v^{t}(n), at this time, the movable conical shell vibrates at the resonance frequency of resonant cavity which is the same as the dominance frequency of noise source.
   The v^{t}(n) is expressed below:

v^{t}(n)=Aₓ^{t}·ωᵢₙ·sin(ωᵢₙ·n+φᵥ^{t})

φᵥ^{t}=φᵥ₋ᵢₙ^{t}+φᵢₙ
These Aₓ^{t}, φᵥ₋ᵢₙ^{t} in the data block 131 are Initial parameters of ideal control target of the movable conical shell, and the ωᵢₙ is derived from the FFT Calculation Module 136. Then, the velocity of ideal control target of the movable conical shell v^{t}(n) is generated by the Module of Generator of Target Signal 133.
On the other hand, the acceleration signal of the movable conical shell a_{cc}(n) obtained by the Sensing Module 110 is expressed as:

a_{cc}(n)=Aₐ·sin(ωₐ·n+φₐ)
It goes through the Module of Signal Integral 132, then so a measured signal of vibrational velocity of the movable conical shell is obtained:

$$v ( n ) = {A}_{v} \cdot sin ( {ω}_{v} \cdot n + {φ}_{v} )$$

$$wherein {A}_{v} = \frac{{A}_{a}}{{ω}_{a}} ; {ω}_{v} = {ω}_{a} ; {φ}_{v} = {φ}_{a} - \frac{π}{2}$$

As the inputs of the DXHS algorithm Update 135, the ωᵢₙ is derived by the FFT calculation Module 136, the A_{ac}(0), φ_{ac}(0) are given by the Initial Parameters Module 137, and the error signal e(n) is derived by the Signal Combiner 134.
From the section of the Summary, vibrational velocity of the movable conical shell v(n) is a function of some sensor's signals and controller's variables:

v(s)=Hᵥ(pₑₓ,pᵢₙ,x,V_{dri}^{dc})
To take a difference between the real velocity of the movable conical shell v(n) and the ideal control target velocity v^{t}(n) as DXHS algorithm residual e(n), adaptively adjust the amplitude increments ΔA_{ac}(n+1) and the phase increments Δφ_{ac}(n+1), so that to make the real velocity v(n) of the movable conical shell match to the ideal control target velocity v^{t}(n) in absorbing control unit 130.
The formulas of the DXHS (Delayed-X Harmonic Synthesizer) algorithm are below:

e(n)=v^{t}(n)−v(n)

ΔA_{ac}(n+1)=−μᵣ·e(n)·sin(ωᵢₙ·n+φ_{ac}(n))

Δφ_{ac}(n+1)=−μₚ·e(n)·cos(ωᵢₙ·n+φ_{ac}(n))

A_{ac}(n+1)=A_{ac}(n)+ΔA_{ac}(n+1)

φ_{ac}(n+1)=φ_{ac}(n)+Δφ_{ac}(n+1)

V_{dri}^{ac}(n)=A_{ac}(n)·sin(ωᵢₙ·n+L·φ_{ac}(n))
In other words, the DXHS algorithm is to control a driving voltage signal of the coil on the movable conical shell to result in a matching the vibrational velocity of the movable conical shell v(s)=ᵥ(pₑₓ, pᵢₙ,x,V_{dri}^{dc}) with the velocity of ideal absorbing control target v^{t}(s)=Hᵥ*(pₑₓ, pᵢₙ, x, I_{coil}^{ac}).
The output of the DXHS algorithm V_{dri}^{ac}(n) enters the Module 101, adding with the voltage of resonance control V_{dri}^{dc} output the coil control voltage:

V_{dri}(n)=V_{dri}^{dc}+V_{dri}^{ac}(n)
Furthermore, the Module 102 converts the coil driving voltage V_{dri}(n) into a V_{dri}^{mod}(n) modulated PWM/PDM so that can use it to drive bridge driving circuit in the Actuating Module 120. A Current Sensor of the Driving Coil 53 is designed in the bridge driving circuit of Actuating Module 120, so the driving current is measured, and it inputs to the Controller 100. Finally, the Actuating Module 120 outputs a driving signal amplified by the bridge circuit to drive the coil in the movable conical shell, in this way, complete entire closed loop control process. The driving voltage V_{dri}^{mod}(n) is not limited to only PWM/PDM format but can be other instead.
The noise absorbing control is a process of energy conversion. There is a balanced energy flow: noise energy=>resonance energy of air=>vibrational energy on the movable conical shell=>electrical energy.
3. Verification of Control Effectiveness
   The average power of work of aerodynamic force Fₐᵢᵣ(t) on the movable conical shell which vibrates with velocity of the ideal control target v^{t}(t):

$${Π}_{air} = \frac{1}{T} {\int }_{0}^{T} {F}_{air} ( t ) \cdot {v}^{r} ( t ) \cdot dt$$

Let have a hypothesis—both Fₐᵢᵣ(t) and v^{t}(t) are harmonics waves, and expressed as:

Fₐᵢᵣ(n)=Aₐᵢᵣ·sin(ωₐᵢᵣ·n+φₐᵢᵣ)

v^{t}(n)=Aₓ^{t}·φᵥ^{t}·sin(ωᵥ^{t}·n+φᵥ^{t})
If Fₐᵢᵣ(t) and v^{t}(t) are the same in phase and frequency, the aerodynamic force has maximum work on the movable conical shell, this situation can be expressed as:

ωₐᵢᵣ=ωᵥ^{t}=ωᵢₙ

φₐᵢᵣ=φᵥ^{t}
The average power of work of electromagnetic force F_{elc}(t) on the movable conical shell which vibrates with velocity of the ideal control target v^{t}(t):

$${Π}_{elc} = \frac{1}{T} {\int }_{0}^{T} {F}_{elc} ( t ) \cdot {v}^{t} ( t ) \cdot dt$$

$${F}_{elc} ( n ) = {F}_{elc}^{d c} + {F}_{elc}^{a c} ( n ) \\ {F}_{elc}^{a c} ( n ) = {C}_{m} \cdot ψ ( x ) \cdot {I}_{coil}^{a c} ( n )$$

Let have the same hypothesis—I_{coil}^{ac}(n) is harmonics wave too, and expressed as:

I_{coil}^{ac}(n)=A_{coil}·sin(ω_{coil}·n+φ_{coil})
If I_{coil}^{ac}(n) and v^{t}(n) are opposite in phase and the same in frequency, the electromagnetic force can absorb the harvested energy on the movable conical shell in the maximum, this situation can be expressed as:

ω_{coil}=ωᵥ^{t}=ωᵢₙ

φ_{coil}=φᵥ^{t}−π
(1) Evaluation criteria of the resonance control
   The primary evaluation criteria of resonance control are below:
      a. A ratio of the resonance amplitude of the resonant cavity Aᵢₙ to the amplitude of the dominant frequency of noise source Aₑₓ, this criterion verifies whether resonant cavity is resonated, that is:

$$\frac{{A}_{in}}{{A}_{ex}}$$

a. How close is the resonance frequency of the resonant cavity ωᵢₙ to the dominant frequency of noise sound ωₑₓ, it is expressed as;

$$\frac{\vert {ω}_{in} - {ω}_{ex} \vert}{{ω}_{ex}}$$

The auxiliary evaluation criteria of resonance control are below:
How much is a phase difference between the phase of the resonance of the resonant cavity φᵢₙ and the phase of the dominant frequency of noise source φₑₓ, that is:

φᵢₙ−φₑₓ
(2) Evaluation criteria of the absorbing control
   The evaluation criteria of work of the aerodynamic force Fₐᵢᵣ(t) are below:
      a. How much is the amplitude difference between the amplitude of displacement of the movable conical shell Aₓ and the amplitude of the ideal control target of the movable conical shell Aₓ^{t}, it is expressed as;

$$\frac{\vert {A}_{x} - {A}_{x}^{t} \vert}{{A}_{x}^{t}}$$

b. How close is the vibrational frequency of the movable conical shell ωₐ to the resonance frequency of the resonant cavity ωᵢₙ, it is expressed as;

$$\frac{\vert {ω}_{a} - {ω}_{in} \vert}{{ω}_{in}}$$

c. How much is a difference between the phase of the vibrational velocity of the movable conical shell φᵥ and the resonance phase of the resonant cavity φᵢₙ, this criterion verifies whether the movable conical shell is synchronously positively resonated, it is expressed as: φᵥ−φᵢₙ
The evaluation criteria of absorbing of the electromagnetic force F_{elc}(t) are below:
   b. How close is the current frequency of the driving coil ω_{coil} to the vibrational frequency of the movable conical shell ωₐ, it is expressed as;

$$\frac{\vert {ω}_{coil} - {ω}_{a} \vert}{{ω}_{a}}$$

c. How close is the phase of the coil current φ_{coil} to the opposite phase of the vibrational velocity of the movable conical shell φᵥ−π, that is:

φ_{coil}−φᵥ+π
this criterion verifies whether the movable conical shell is inversely negatively resonated by the electromagnetic force for absorbing the vibration energy.

### BRIEF DESCRIPTION OF THE DRAWINGS

The foregoing and/or other objects features, and advantages of the invention will become more apparent from the following description of a preferred embodiment with reference to the accompany drawings in which like reference numerals designate like elements and wherein:

FIG. 1A is a vertical cross-sectional view of the absorber according to embodiment of the invention, taken along line 1-1 of FIG. 1B;

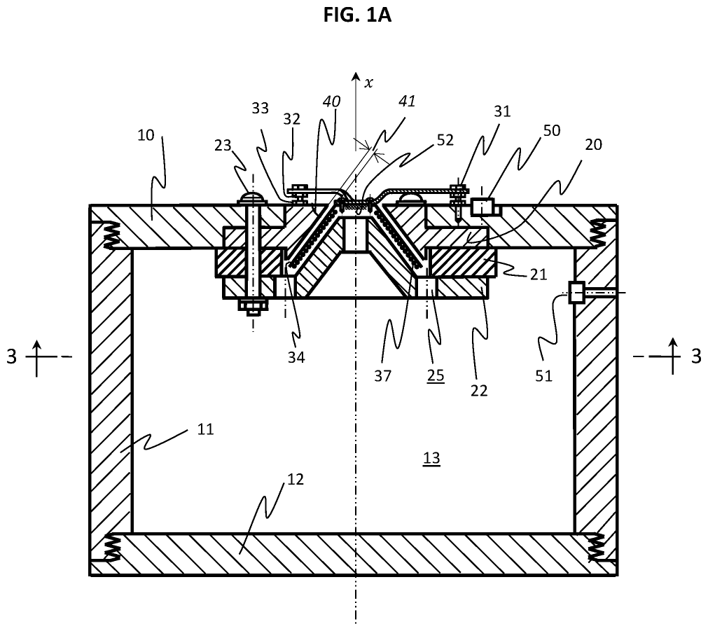

FIG. 1B is a top plane view of the FIG. 1A;

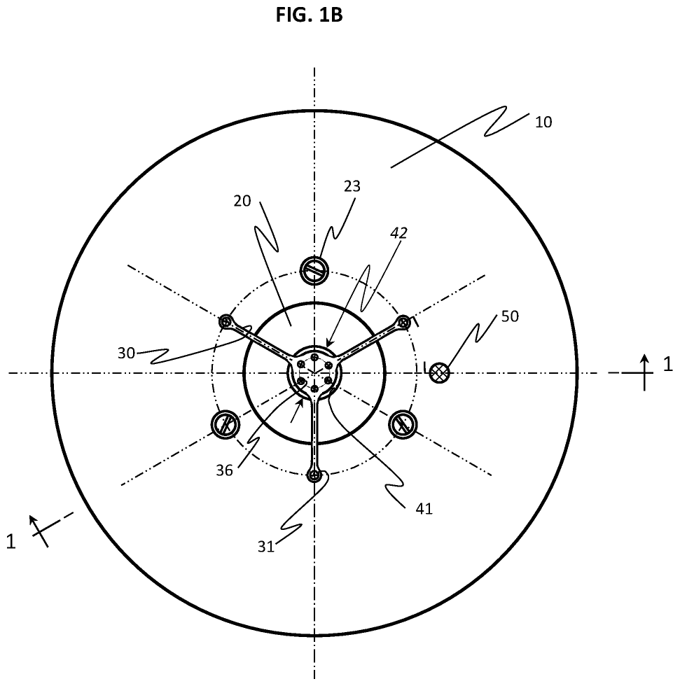

FIG. 1C is a transverse cross-sectional view, taken along line 3-3 of the FIG. 1A;

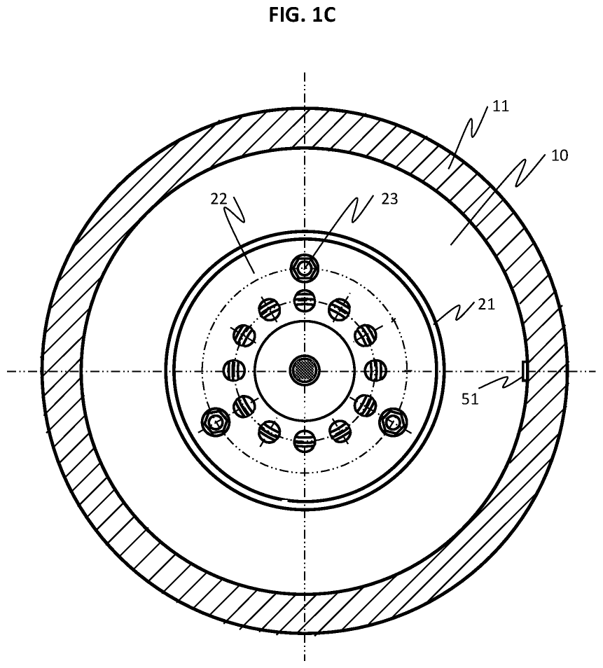

FIG. 2 is a control block diagram illustrating architecture of the active noise absorption method and device with resonance frequency tracking;

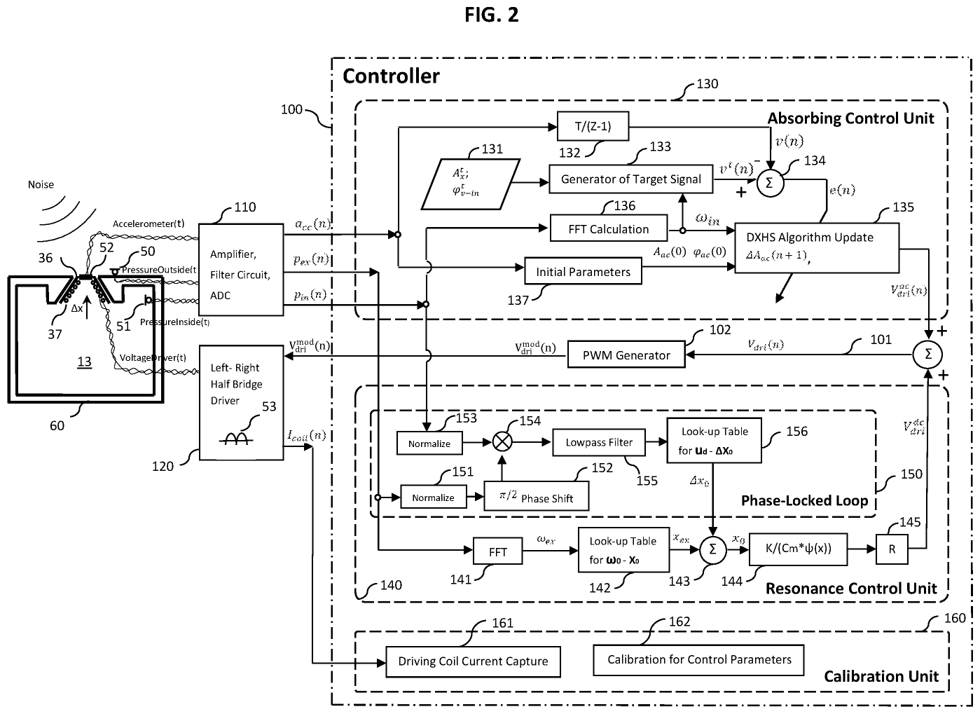

FIG. 3 is a block diagram of electro-mechanical model of the movable conical shell.

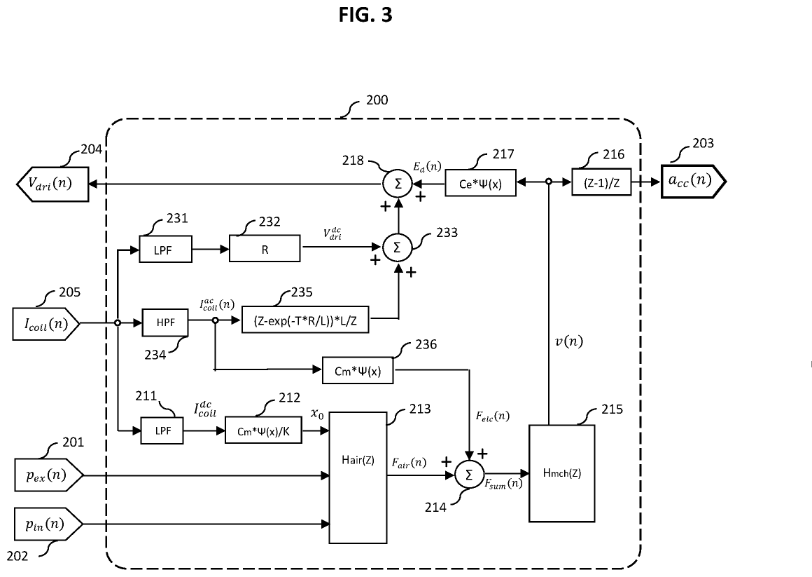

### REFERENCE MARKS IN THE DRAWINGS

10 Top Cover
11 Cylindrical Housing
12 Bottom Cover
13 Resonant Cavity
20 Upper Magnetic Pole
21 Magnet
22 Lower Magnetic Pole
23 Fastener for Magnetic Components
25 Through Holes of the Lower Magnetic Pole
30 Trilobal Metal Springs
31 Fastener for Outer Ends of the Trilobal Metal Springs
32 Upper Screw Nuts of the Fastener for the Outer Ends
33 Lower Screw Nuts of the Fastener for the Outer Ends
34 Bracket of Conical shaped Shell
36 Fastener for the Bracket of Conical Shell
37 Driving Coil Winding on Inner Wall of the Bracket of Conical Shell
40 Conical Angle of Conical Shaped Annular Aperture—β
41 Opening Gap of Conical Shaped Annular Aperture—δ
42 Diameter of Upper Conical Aperture of the Cavity—D₀
50 Acoustic Sensor Outside of the Resonant Cavity
51 Acoustic Sensor Inside of the Resonant Cavity
52 Accelerometer attached into the Bracket of Conical Shaped Shell
53 Current Sensor of the Driving Coil
60 Mechanical Schematic of the absorber
100 Controller of the Method and Device
101 Voltage Control Signal for the Driving Coil
102 Generator of PWM/PDM for Bridge Driving
110 Sensing Module
120 Actuating Module
130 Absorbing Control Unit
131 Parameters of Ideal Control Target of the Movable Conical Shell
132 Signal Integral
133 Generator of Target Signal
134 Signal Combiner
135 Update Module of DXHS algorithm
136 FFT calculation Module of ωᵢₙ
137 Initial Parameters Module
140 Resonance Control Unit
141 FFT calculation Module of ωₑₓ
142 Look-up Table for ωₒ−xₒ
143 Signal Combiner
144 Electro-kinetic Coefficient
145 Resistance of the Driving Coil
150 Phase-Locked Loop
151 Normalized Module
152 π/2 Phase Shift Module
153 Normalized Module
154 Signal Product
155 Lowpass Filter Module
156 Look-up Table for u_{d}−Δxₒ
160 Calibration Unit of the Control Parameters
161 Driving Coil Current Capture Module
162 Calibration Module for the Control Parameters
200 Electric-kinetic Model of the Movable Conical Shell
201 Acoustic Signal Outside of the Resonant Cavity
202 Acoustic Signal Inside of the Resonant Cavity
203 Acceleration Signal of the Movable Conical Shell
204 Voltage Signal for the Driving Coil
205 Current Signal for the Driving Coil
211 Lowpass Filter Module for Measurement Current
212 Electro-kinetic Coefficient for x₀
213 Aerodynamic Transfer Function of the Movable Conical Shell
214 Signal Combiner
215 Velocity Transfer Function of the Movable Conical Shell
216 Differential Module
217 Potential inducing Coefficient
218 Signal Combiner
231 Lowpass Filter Module for Measurement Current
232 Resistance of the Driving Coil
233 Signal Combiner
234 High-pass Filter Module for Measurement Current
235 First-order Proportional Differential Module
236 Electro-kinetic Coefficient

1. An active noise absorption method and device, comprising:
a Helmholtz resonator (resonant cavity) with an adjustable conical shaped annular aperture used for harvesting noise energy;
a resonance control package including a movable conical shell with coil and two magnetic poles served as an actuator for tracking dominant frequency of noise source and absorbing converted vibrational energy taken by the movable conical shell;
a sensing & actuating modules used to amplify, filter sensing signals, and to drive a driving coil which current is measured;
a group of sensors including two acoustic sensors positioned outside and inside of the resonator, an accelerometer of the movable conical shell and a current sensor of the driving coil;
and
a controller configured to acquire the sensor signals and calculate output in real time in accordance with control algorithm to ensure resonance is tracked and harvested energy is absorbed efficiently by applying a required current to the driving coil.

2. An algorithm of resonance control for tracking of absorbed noise dominant frequency is performed by adjusting opening gap of a conical annular aperture between the resonant cavity and the movable conical shell by means of adjustment of manual screw nuts for selection of operating frequency band and adaptively combined adjustment of FFT (Fourier Fast Transform) coarse adjustment and PLL (Phase-Locked Loop) fine adjustment.

3. An algorithm of absorbing control is used to maximize absorption of vibrational energy on the movable conical shell produced by the resonance by means of controlling vibrational velocity vector of the movable conical shell to match with velocity vector of ideal control target using DXHS (Delayed-X Harmonic Synthesizer) algorithm which controls electromagnetic force to absorb a balance energy flow on the movable conical shell coming from the resonant air.
